(19) United States
(12) Patent Application Publication
(10) Pub. No.: US 2014/0126092 A1
(43) Pub. Date: May 8, 2014

(54) ELECTRICAL SURGE SUPPRESSOR

(71) Applicant: Bill Rush Alexander, Calera, AL (US)

(72) Inventor: Bill Rush Alexander, Calera, AL (US)

(21) Appl. No.: 13/672,630

(22) Filed: Nov. 8, 2012

(51) Int. Cl. H02H 9/04

(52) U.S. Cl. CPC H02H 9/042
USPC 361/56

(57) ABSTRACT

A surge or lightning spike suppressor has visual and electrical indications of its operation and can prevent voltage spikes from harming electrical and electronic components by clamping voltage spikes at a safe level and, after the spike is past, the voltage is allowed to continue to supply the equipment. The surge suppressor can be easily replaced, if the need arises, without having to isolate the incoming electrical service. A visual indicator, such as an indicator lamp, can illuminate to designate when the surge suppressor is in operation.

### BACKGROUND OF THE INVENTION

The present invention relates to electrical surge suppressors and, more particularly, to a surge or lightning spike suppressor having visual and electrical indications of its operation that can operate to quickly and efficiently clamp surges at a safe level.

Voltage spikes can be received into electrical circuits. These voltage spikes can harm electrical and electronic equipment.

Conventional systems to prevent voltage spikes from are hard wired into an electrical system. They can only be replaced by qualified workers, after having the power removed from the equipment. This can result in significant down time of the equipment.

Other conventional systems are slow in operation, large in physical size and can end up being too complex for the intended installation.

As can be seen, there is a need for a surge or lightning spike suppressor that is fast-acting and can be easily and quickly changed out of service without having to isolate incoming electrical service.

### SUMMARY OF THE INVENTION

In one aspect of the present invention, a surge suppressor comprises an enclosure; a male connector operable to connect to a female connector outside the enclosure; a line terminal of the male connector electrically connected to a fuse; first and second diodes electrically connected to the fuse, the first and second diodes connected in series between the line terminal and a ground or neutral terminal of the male connector; a lamp electrically connected to the fuse, the lamp operable to illuminate when the surge suppressor is operable; and a metal oxide varistor electrically connected to the fuse, the metal oxide varistor connected between the line terminal and the ground or neutral terminal of the male connector.

In another aspect of the present invention, a method for protecting a circuit from electrical surges comprises connecting a female connector to the circuit; plugging the female connector into a male connector disposed outside an enclosure; passing line voltage from the circuit to a line terminal of the male connector that is electrically connected to a fuse; passing the line voltage from the fuse to first and second diodes electrically connected to the fuse, the first and second diodes connected in series between the line terminal and a ground or neutral terminal of the male connector; passing the line voltage to a lamp electrically connected to the fuse, the lamp operable to illuminate when the surge suppressor is operable; and passing line voltage to a metal oxide varistor electrically connected to the fuse, the metal oxide varistor connected between the line terminal and the ground or neutral terminal of the male connector.

These and other features, aspects and advantages of the present invention will become better understood with reference to the following drawings, description and claims.

### BRIEF DESCRIPTION OF THE DRAWINGS

FIG. 1 is a perspective view of an electrical surge suppressor according to an exemplary embodiment of the present invention;

FIG. 2 is a circuit board layout of the electrical surge suppressor of FIG. 1; and

FIG. 3 is an electrical schematic drawing of the electrical surge suppressor of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a surge or lightning spike suppressor having visual and electrical indications of its operation. The surge suppressor can prevent voltage spikes from harming electrical and electronic components by clamping voltage spikes at a safe level and, after the spike is past, the voltage is allowed to continue to supply the equipment. The surge suppressor can be easily replaced, if the need arises, without having to isolate the incoming electrical service. A visual indicator, such as an indicator lamp, can illuminate to designate when the surge suppressor is in operation. The surge suppressor can protect against various voltage spikes, such as electrical motor starts, motor stops, lightning strikes, and the like.

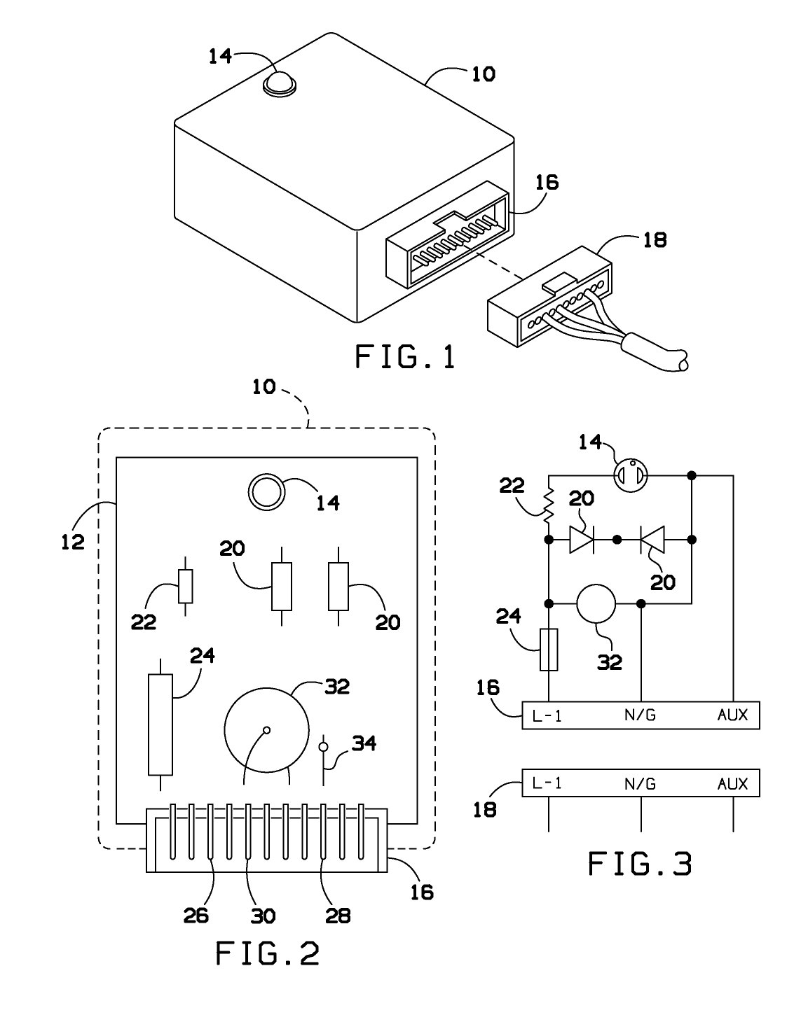

Referring now to FIGS. 1 through 3, an electrical surge suppressor can include a male connector 16 disposed through a housing 10 having a circuit board 12 disposed within the housing 10 and electrically connected to the male connector 16. A female connector 18 can be connected to the inlet power of a circuit to be protected.

The female connector 18 can be electrically connected with the male connector 16 to provide power from the circuit to be protected to the circuit board 12. The male connector 16 and female connector 18 can include a line voltage terminal 26, a ground or neutral terminal 28 and an auxiliary terminal 30. The line voltage terminal 26 can be connected to line voltage of the circuit to be protected and the ground or neutral terminal 28 can be connected to ground or neutral of the circuit to be protected.

The line voltage terminal 26 can be electrically connected through a fuse 24. For example, a five ampere fuse can be used and can open if the diodes 20 (described below) have shorted due to an excessive amount of current being clamped, thus allowing protected equipment on the circuit to continue to function.

The fuse 24 can electrically connect with diodes 20, arranged head to tail, to clamp voltage spikes that are above a safe level. The diodes 20 can be selected for a particular desired safe voltage level. If there is a voltage spike above this safe level, the diodes 20 will quickly route the voltage spike to ground, protecting equipment on the circuit. Typically, the diodes 20 react within picoseconds to clamp the voltage to ground.

The fuse 24 can also be electrically connected with a resistor 22 and an indicator lamp 14. The indicator lamp 14 can also be connected to the neutral or ground terminal 28. The indicator lamp 14 illuminates so long as the fuse 24 is not blown or tripped.

A metal oxide varistor (MOV) 32 can be disposed between the line side and neutral/ground side, connecting on the line side between the fuse 24 and the diodes 20. The MOV 32, while slower to act as compared to the diodes 20, can handle a larger current load than the diodes 20 and can help clamp larger spikes.

The socket design of the surge suppressor of the present invention makes it very easy to install and replace, if needed. No hard wiring of the working components or loss of power to the equipment is necessary. If the diodes 20 short due to too large a current load, the fuse 24 will blow, allowing any protected equipment to remain in working condition. At this point, the indicator lamp 14 will go out, showing that the surge suppressor needs to be replaced.

In some embodiments, the system can include a remote operation output indication terminal 34. This terminal 34 can be used to send a remote signal to monitor the status of the surge suppressor.

Typically, the surge suppressor of the present invention can be installed close to the incoming power to a lighting panel, circuit breaker box, or the like, where it can work the best. Stopping any voltage spikes that occur on the line as close to the incoming power is desired.

It should be understood, of course, that the foregoing relates to exemplary embodiments of the invention and that modifications may be made without departing from the spirit and scope of the invention as set forth in the following claims.

What is claimed is:

1. A surge suppressor comprising:
an enclosure;
a male connector operable to connect to a female connector outside the enclosure;
a line terminal of the male connector electrically connected to a fuse;
first and second diodes electrically connected to the fuse, the first and second diodes connected in series between the line terminal and a ground or neutral terminal of the male connector;
a lamp electrically connected to the fuse, the lamp operable to illuminate when the surge suppressor is operable; and
a metal oxide varistor electrically connected to the fuse, the metal oxide varistor connected between the line terminal and the ground or neutral terminal of the male connector.

2. The surge suppressor of claim 1, further comprising a resistor disposed between the fuse and the lamp.

3. The surge suppressor of claim 1, further comprising a remote operation output indication terminal.

4. The surge suppressor of claim 1, wherein the fuse is a five ampere fuse.

5. The surge suppressor of claim 1, wherein the first and second diodes, the lamp, the metal oxide varistor and the fuse are disposed on a circuit board.

6. The surge suppressor of claim 1, wherein the female connector connects to a circuit where surge suppression protection is desired.

7. A method for protecting a circuit from electrical surges, the method comprising:
connecting a female connector to the circuit;
plugging the female connector into a male connector disposed outside an enclosure;
passing line voltage from the circuit to a line terminal of the male connector that is electrically connected to a fuse;
passing the line voltage from the fuse to first and second diodes electrically connected to the fuse, the first and second diodes connected in series between the line terminal and a ground or neutral terminal of the male connector;
passing the line voltage to a lamp electrically connected to the fuse, the lamp operable to illuminate when the surge suppressor is operable; and
passing line voltage to a metal oxide varistor electrically connected to the fuse, the metal oxide varistor connected between the line terminal and the ground or neutral terminal of the male connector.

8. The method of claim 7, further comprising blowing the fuse upon shorting out the first and second diodes.

9. The method of claim 8, further comprising replacing the enclosure by unplugging the female connector from the male connector when the lamp is not illuminated.

10. The method of claim 9, further comprising continuing to supply power to the circuit when replacing the enclosure.
